(19) United States
(12) Patent Application Publication
(10) Pub. No.: US 2026/0222752 A1
(43) Pub. Date: Jul. 30, 2026

(54) METADATA-BASED AUDIO SIGNAL PROCESSING

(71) Applicant: Bose Corporation, Framingham, MA (US)

(72) Inventors: David Casey, Thousand Oaks, CA (US); Nathan Blagrove, Hanover, MA (US)

(21) Appl. No.: 19/238,649

(22) Filed: Jun. 16, 2025

Related U.S. Application Data
(60) Provisional application No. 63/749,306, filed on Jan. 24, 2025.

(51) Int. Cl. H04S 7/00; G11B 27/34

(52) U.S. Cl. CPC H04S 7/00; G11B 27/34

(57) ABSTRACT

Various implementations include audio devices and methods for controlling audio output. Certain implementations include a method of controlling audio device output, including: receiving an audio file or audio stream for output at an audio device, the audio file or audio stream provided with metadata defining audio output settings, wherein the audio file or audio stream is in a standard format, evaluating the metadata for corresponding output capabilities at the audio device, and if the audio device does not have corresponding output capabilities defined by the metadata, outputting the audio file or audio stream in the standard format.

### PRIORITY CLAIM

This application claims priority to U.S. Provisional Application No. 63/749,306 (METADATA-BASED AUDIO SIGNAL PROCESSING), filed Jan. 24, 2025, the entire contents of which are hereby incorporated by reference.

### TECHNICAL FIELD

This disclosure generally relates to audio systems. More particularly, the disclosure relates to metadata-based audio signal processing in audio systems.

### BACKGROUND

Certain types of audio content can benefit from particular signal processing, for example, equalization, volume control, mode control, etc. However, certain conventional systems do not effectively control signal processing based on audio data.

### SUMMARY

All examples and features mentioned below can be combined in any technically possible way.

Various implementations include audio devices and methods for controlling audio output. Certain implementations include a method of controlling audio device output, including: receiving an audio file or audio stream for output at an audio device, the audio file or audio stream provided with metadata defining audio output settings, wherein the audio file or audio stream is in a standard format, evaluating the metadata for corresponding output capabilities at the audio device, and if the audio device does not have corresponding output capabilities defined by the metadata, outputting the audio file or audio stream in the standard format.

Particular implementations include a device having a processor configured to: receive an audio file or audio stream for output at an audio device, the audio file or audio stream provided with metadata defining audio output settings, wherein the audio file or audio stream is in a standard format, evaluate the metadata for corresponding output capabilities at the audio device, and if the audio device does not have corresponding output capabilities defined by the metadata, output the audio file or audio stream in the standard format. In some cases, the device includes an audio device having an electro-acoustic transducer coupled with the processor.

Additional particular implementations include a method that includes: classifying a library of audio files or audio streams according to content type; and appending the library with metadata classifiers for subsequent playback according to the metadata in a standard audio format.

Implementations may include one of the following features, or any combination thereof.

In some aspects, the metadata includes at least one of descriptive metadata or prescriptive metadata.

In some aspects, the metadata includes both descriptive metadata and prescriptive metadata. In some examples, where the metadata includes both descriptive metadata and prescriptive metadata and a conflict exists between the descriptive metadata and prescriptive metadata, the prescriptive metadata controls over the descriptive metadata.

In some aspects, the method further includes, if the metadata includes prescriptive metadata, applying specified signal processing instructions to audio output at the audio device according to the prescriptive metadata.

In some aspects, the prescriptive metadata specifies how to render content in the audio file or audio stream with the specified signal processing instructions that are configured to override conflicting default audio output settings for the audio device. In one example, prescriptive metadata includes: {FREQCE} =Apply Flat EQ and Center Channel Extraction mode regardless of content type.

In some aspects, the method further includes, if the metadata includes descriptive metadata and not prescriptive metadata, selecting an output mode for the audio output at the audio device from a predefined set of output modes.

In some aspects, the descriptive metadata describes the nature of content in the audio file or the audio stream. In some examples, selecting an output mode is based on heuristics or predefined rules according to the nature of the content. In some examples, the nature of the content can include one or more of: Music (MU), Podcast (PO), Movie (MO), Spoken Word (SW), Episodic (EP), or Gaming (GA). In a particular example, where descriptive metadata includes music (MU), the output mode can include applying default tuning, and avoiding pausing during interruptions.

In some aspects, if the audio device has corresponding output capabilities defined by the metadata, outputting the audio file or audio stream according to the metadata is performed by applying at least one of: an equalization adjustment, a spatialization adjustment, a virtualization adjustment, or an anchoring adjustment to the audio file or audio stream.

In some aspects, the standard format includes at least one of a stereo format or a stereo transport format. In particular examples, the standard format may explicitly exclude object-based audio formats. In such cases, the processor is configured to process only channel-based stereo or surround signals, or to ignore object metadata that conflicts with defined metadata.

In some aspects, the metadata includes a set of indicators of audio output settings based on audio output device type.

In some aspects, the set of indicators includes two or more indicators for assigning audio output settings in response to detecting two or more audio output devices, where the set of indicators is applied differently to distinct audio output devices. In some examples, the audio output devices include stereo paired speakers, grouped speakers, speakers paired with an open-ear wearable audio device, a soundbar paired with a wearable audio device, etc. In additional implementations, the metadata may include synchronization markers and/or role designations, e.g., to enable coordinated playback across a set of two or more devices. For example, a wearable audio device may be instructed to render only spatial effects while a paired soundbar renders dialog or low-frequency effects, with both synchronized to a shared clock or frame reference.

In some aspects, the method further includes receiving an input from a user interface to disable the metadata-based evaluation for corresponding output capabilities at the audio device, and outputting the audio file or audio stream in the standard format in response to receiving the input.

In some aspects, the evaluating is performed at the audio device.

In some aspects, the audio device has limited processing capability. In certain examples, the audio device with limited processing capability includes a wearable audio device or a portable audio device.

In some aspects, the metadata is provided with a metadata transport mechanism.

In some aspects, the metadata is provided via at least one of: file-embedded tags, Bluetooth transport protocols, Wi-Fi, general wireless protocols, non-audible transports such as ultrasound, encoded carrier signals in the audio content, or a companion data channel associated with the audio stream. In some examples, the metadata is appended to the title of the content. In certain examples, the content type is indicated by a set of content-based features represented by a unique two-letter code. In some examples, the content type is one of a group of predefined content types.

In some aspects, evaluating the metadata is performed automatically without user input.

In some aspects, the method further includes providing a digital audio workstation (DAW) plug-in with a menu of metadata assignment options.

In some aspects, the menu of metadata assignment options includes options for assigning at least one of prescriptive metadata or descriptive metadata to each audio file or audio stream. For example, the menu of metadata assignment options can include options for assigning prescriptive metadata to each audio file or stream such as defining equalization, distribution, virtual speakers, level, spatialization, or anchoring.

In some aspects, the method further includes: classifying a library of audio files or audio streams according to content type; and appending the library with metadata classifiers for subsequent playback according to the metadata in a standard audio format.

In some aspects, the audio device includes at least one of: an audio headset, a fixed speaker, a portable speaker, or a vehicle audio system.

In some cases, the group of content types is predefined.

In some aspects, the controller is further configured to select the audio output mode based on at least one secondary factor including, user movement, proximity to a multimedia device, proximity to an external speaker, proximity to another wearable audio device, or presence in a vehicle.

Two or more features described in this disclosure, including those described in this summary section, may be combined to form implementations not specifically described herein.

The details of one or more implementations are set forth in the accompanying drawings and the description below. Other features, objects and advantages will be apparent from the description and drawings, and from the claims.

### BRIEF DESCRIPTION OF THE DRAWINGS

FIG. 1 is a data flow diagram illustrating aspects of metadata-based audio control according to various implementations.

FIG. 2 is a flow diagram illustrating processes in a method according to various implementations.

FIG. 3 is a flow diagram illustrating processes in a method according to various additional implementations.

It is noted that the drawings of the various implementations are not necessarily to scale. The drawings are intended to depict only typical aspects of the disclosure, and therefore should not be considered as limiting the scope of the implementations. In the drawings, like numbering represents like elements between the drawings.

### DETAILED DESCRIPTION

This disclosure is based, at least in part, on the realization that adaptively controlling audio output based on content can enhance the user experience.

Additional details of content-based audio control are described for example in U.S. patent application Ser. No. 18/238,668 (Content-Based Audio Spatialization, filed Aug. 28, 2023) and U.S. patent application Ser. No. 19/027,307 (Audio Device with Machine Learning (ML) Based Content Detection, filed Jan. 17, 2025), the entire contents of each of which is incorporated by reference herein.

Particular aspects are described in the context of wearable devices such as those provided by Bose Corporation (Framingham, MA, USA), for example, Bose Ultra Open Earbuds, Bose QuietComfort Earbuds, Bose QuietComfort Ultra Headphones, Bose QuietComfort Headphones; as well as speakers provided by Bose Corporation, for example, Bose Smart Soundbar varieties, television speakers (e.g., the Bose TV Speaker), home theater speakers (e.g., the Bose Surround Speaker varieties and/or Bose Bass Module varieties), portable speakers such as a portable smart speaker (e.g., one of the Bose Soundlink varieties or the Bose Portable Smart Speaker) or a portable professional speaker such as the Bose S1 Pro Portable Speaker. In further implementations, audio devices as described herein can include vehicle audio systems such as speaker systems in an automobile, electric vehicle, or other transport vehicle. Additional audio devices can include pass-through or control devices such as amplifiers and/or switches.

Certain conventional audio systems employ audio control and other audio output adjustments without consideration for content type. Because different types of content can benefit from audio control (e.g., mode control, volume control, spatialization, virtualization, orchestration, etc.) in distinct ways, these conventional systems can have deficiencies.

The systems and methods disclosed according to various implementations use content metadata to adaptively control audio output. A particular approach includes automatically selecting signal processing for audio output based on content metadata. In some aspects, automatically selecting the output mode is performed without user input.

Commonly labeled components in the FIGURES are considered to be substantially equivalent components for the purposes of illustration, and redundant discussion of those components is omitted for clarity.

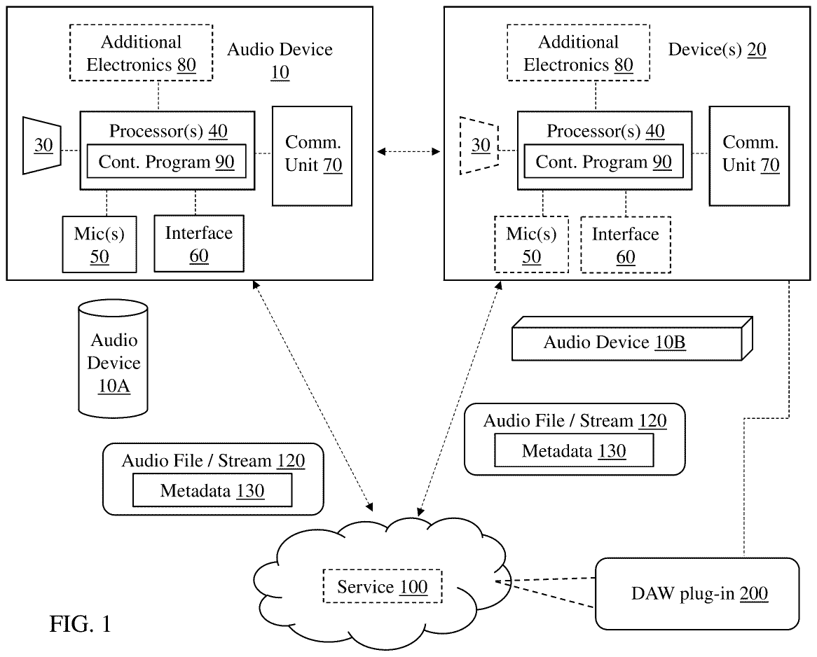

Various implementations include audio devices and methods for controlling audio output. Certain implementations include a method of controlling audio device output. FIG. 1 is a schematic data flow diagram illustrating an audio device 10 interfacing with an additional device 20 according to various implementations. In some cases, the additional device 20 is referred to as a source device and/or a smart device, e.g., an electronic device having network communication capabilities and processing capabilities. It is understood that in some cases, the audio device 10 can include functions described relative to the device 20, e.g., where an audio file or audio stream is stored or otherwise supplied by an integrated device 20 at the audio device 10. In other cases, the device 20 is separate (e.g., physically separate) from the audio device 10, e.g., where device 20 is a smart device such as a smart phone, tablet, computing device, amplifier unit, etc. In particular examples, the audio device 10 includes at least one electro-acoustic transducer 30 (e.g., a single driver or an array of drivers) and a processor 40 coupled with the transducer(s) 30. In additional, optional implementations, the audio device 10 includes one or more microphones 50 coupled with the processor 40. In some optional implementations, the audio device 10 includes an interface 60, e.g., a user interface enabling inputs and/or outputs such as one or more buttons, touch screens, voice command interfaces, etc. Additional implementations include a communications unit (or interface) 70 configured to communication with additional devices (e.g., device 20, and additional audio devices 10a, 10b, 10c, etc.) via one or more conventional communication protocols, e.g., Wi-Fi, Bluetooth (BT), BT Low Energy (BLE), broadcast, SimpleSync (developed by Bose Corporation, Framingham, MA, USA), general wireless protocols, non-audible transports such as ultrasound, via encoded carrier signals, direct (i.e., wired) connection, etc. Additional, optional electronics 80 at the audio device 10 can include sensors such as orientation sensors, optical sensors, capacitive sensors, etc., as well as communications equipment. In some cases where the (e.g., source) device 20 is paired with audio device 10, those devices are referred to as a source and sink, respectively. In some cases, the audio device 10 can be directly connected (e.g., via a network connection) to an audio service 100, e.g., an audio file and/or streaming platform 100, or can be connected to the audio service 100 via device 20. Additional audio devices 10A, 10B are also illustrated as examples of further devices that could be present in a given space, e.g., multiple speakers in a room, home, office, house of worship, or other venue. Further, a set of audio devices 10 can form a system such as a vehicle audio system or an installed audio system in a venue.

In particular cases, the processor 40 includes a chip or chipset that is configured to run a metadata-based audio control program (cont. program) 90 to control output functions at one or more audio devices 10, e.g., in a space such as in a room, a home, an office, meeting space, etc. As shown in FIG. 1, the processor 40 (and control program 90) functions can be performed at the audio device(s) 10 and/or at source device 20.

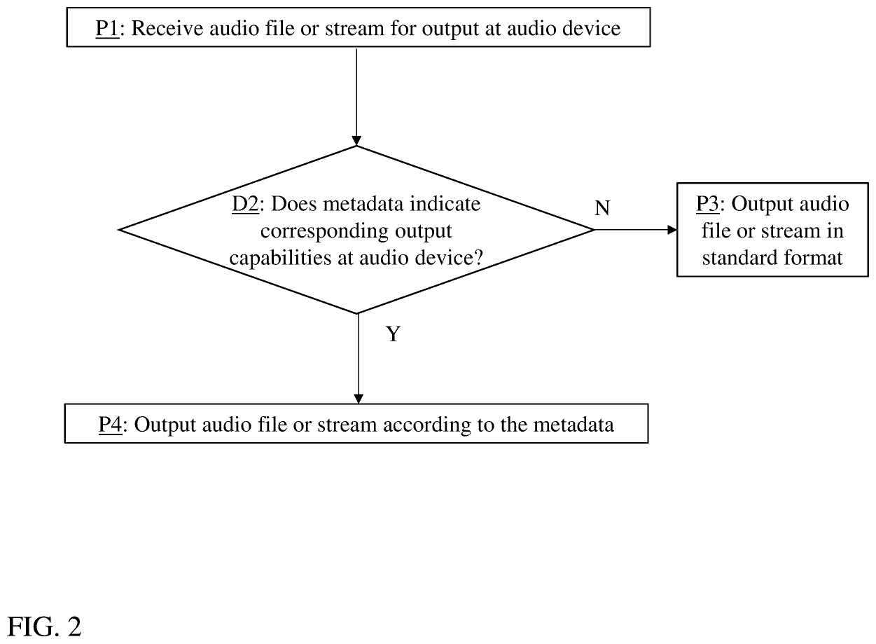

FIG. 2 shows a flow diagram illustrating processes in a method performed by the processor 40 (e.g., running control program 90) to control output at audio device(s) 10 based on audio file or stream metadata. With reference to FIGS. 1 and 2, the control program 90 is configured to:
P1: receive an audio file or audio stream (file or stream) 120 for output at an audio device 10. As noted herein, in certain cases, the audio file or audio stream 120 is stored locally at the audio device 10 and/or source device 20, or can be accessed via an audio service 100 (e.g., over a network connection). In particular implementations, the audio file or audio stream 120 is provided with metadata 130 (e.g., via one or more metadata transport mechanisms described herein) defining audio output settings. In some cases, the audio file or audio stream 120 is in a standard format. In some aspects, the standard format includes a stereo format and/or a stereo transport format. In particular cases, the standard format excludes object-based formatting, or the processor 40 is otherwise configured to ignore object-based formatting. In particular examples, the standard format may explicitly exclude object-based audio formats such as Dolby Atmos (which can be carried by Dolby Digital, or Dolby Digital Plus), or MPEG-H. In such cases, the processor is configured to process only channel-based stereo or surround signals, or to ignore object metadata that conflicts with (e.g., SonicSync-defined) metadata.

In further non-limiting example implementations, such as where the audio device 10 is part of an out-loud speaker system, the processor 40 can be configured to act in a multi-channel rendering configuration at least in part using guided metadata, e.g., if such metadata overlaps with the description of an object-based renderer.

D2: evaluate the metadata 130 for corresponding output capabilities at the audio device 10. In particular cases, evaluating the metadata 130 is performed automatically without user input. In some examples, the metadata 130 is evaluated in response to receiving the audio file or stream 120. In further examples, metadata 130 is automatically evaluated when one or more operating modes is enabled and/or active, e.g., a metadata-based control operating mode. In some cases, the metadata-based audio output control can be disabled, e.g., via a user interface command. For example, in response to receiving an input from a user interface (e.g., interface 70) to disable the metadata-based evaluation for corresponding output capabilities at the audio device 10, the processor 40 is configured to output the audio file or audio stream 120 in the standard format. In still further implementations, select aspects of metadata-based control operating modes can be disabled, e.g., based on user preferences. For example, a user may wish to override one or more aspects of an output mode without necessarily disabling the metadata-based audio output control altogether. In a non-limiting example, a content creator may use metadata 130 to specify an immersion mode (FR) with a Flat Response EQ, but the user may wish to only override the Flat Response EQ, e.g., with their Custom EQ.

Returning to FIG. 2, following evaluation of the metadata 130 for corresponding output capabilities at the audio device 10, process P3 includes: if the audio device 10 does not have corresponding output capabilities defined by the metadata 130 (No to D2), output the audio file or audio stream 120 in the standard format; and

P4: if the audio device 10 does have corresponding output capabilities defined by the metadata 130 (Yes to D2), output the audio file or audio stream 120 according to the metadata 130. In some aspects, if the audio device 10 has corresponding output capabilities defined by the metadata, outputting the audio file or audio stream 120 according to the metadata 130 includes applying at least one of: an equalization adjustment, a spatialization adjustment, a virtualization adjustment, or an anchoring adjustment to the audio file or audio stream 120.

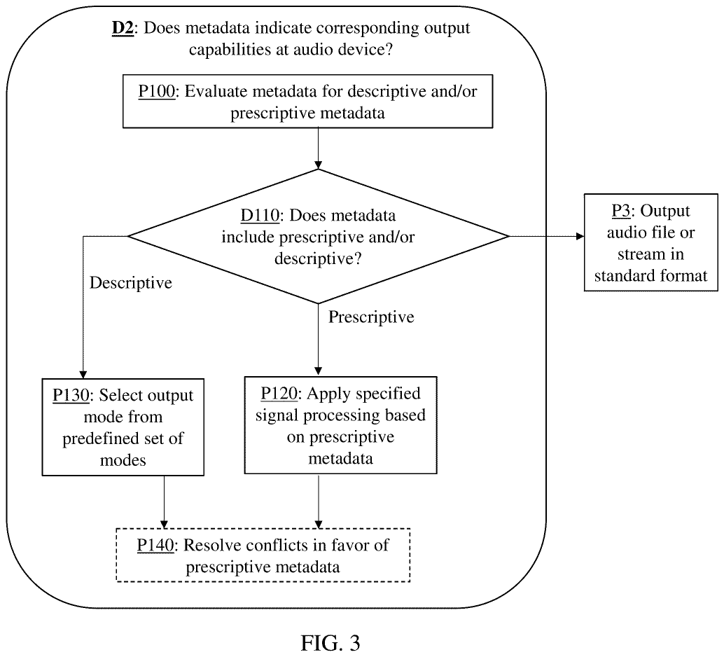

In some cases, evaluating the metadata 130 in decision D2 includes evaluating the metadata 130 based on a type of metadata present (if any). FIG. 3 shows a flow diagram illustrating processes in evaluating the metadata 130 according to various implementations. In some aspects, the metadata 130 includes descriptive metadata 140 and/or prescriptive metadata 150. In particular aspects, the metadata 130 includes both descriptive metadata 140 and prescriptive metadata 150.

In a first process (P100), the processor 40 (e.g., running control program 90) evaluates the metadata 130 for descriptive metadata 140 and/or prescriptive metadata 150.

In some aspects, the descriptive metadata 140 describes the nature of content in the audio file or the audio stream 120. In some non-limiting examples, the nature of the content can include one or more of: Music (MU), Podcast (PO), Movie (MO), Spoken Word (SW), Episodic (EP), or Gaming (GA). Distinct from descriptive metadata 140, prescriptive metadata 150 specifies how to render content in the audio file or audio stream 120 with specified signal processing instructions that are configured to override conflicting default audio output settings for the audio device 10.

Based on the evaluation of the metadata 130, the processor 40 is configured to take one or more actions (at decision D110) to control audio output of the audio file or stream 120. As indicated in FIG. 2, if the metadata 130 does not include descriptive 140 or prescriptive 150 metadata, the processor 40 is configured to output the audio file or audio stream 120 in the standard format, as shown in process (P3).

If the metadata 130 includes prescriptive metadata 150, in process P120, specified signal processing instructions are applied to audio output at the audio device 10 according to the prescriptive metadata. In one example, prescriptive metadata 150 includes: {FREQCE}=Apply Flat EQ and Center Channel Extraction mode regardless of content type. Additional examples include {FREQLR} to apply Flat EQ and Large Room simulation (prescriptive), with an optional {MO} tag to indicate Movie content (descriptive). In certain examples where prescriptive metadata takes precedence over descriptive metadata, the processor 40 will follow the rendering behavior defined by {FREQLR}, regardless of any default behavior typically associated with the {MO} content type. In another example, {DCEQPO} would apply Default EQ (prescriptive) while also signaling that the content is a podcast (descriptive). In this case, the prescriptive EQ setting will control playback.

In some cases, if the metadata 130 includes descriptive metadata 140 and not prescriptive metadata 150, process P130 includes selecting an output mode for the audio output at the audio device 10 from a predefined set of output modes. In some examples, selecting the output mode is based on heuristics or predefined rules according to the nature of the content. In a particular example, where descriptive metadata includes music (MU), the output mode can include applying default tuning, and avoiding pausing during interruptions.

In some aspects, the metadata 130 includes both descriptive metadata 140 and prescriptive metadata 150. In such cases, prescriptive metadata 150 can control over descriptive metadata 140, e.g., if a conflict exists, as illustrated in optional process P140 in FIG. 3. In such cases, the prescriptive metadata is interpreted as explicit creator intent and is configured to override any conflicting default or descriptive-based behaviors. For example, if descriptive metadata indicates the content is a podcast (suggesting pause-on-interruption behavior), but prescriptive metadata includes {DS} for immersive disabled, the prescriptive setting takes precedence, disabling immersive features regardless of the default podcast profile.

In further implementations, the metadata 130 includes a set of indicators of audio output settings based on audio output device type, e.g., whether the audio device(s) 10 includes open-ear (non-occluding) headphones, occluding headphones (e.g., earbuds or on-ear headphones), a portable speaker, a soundbar, a paired speaker, an entertainment audio system, a vehicle audio system, etc. In some aspects, the set of indicators includes two or more indicators for assigning audio output settings in response to detecting two or more audio output devices 10. For example, the set of indicators is applied differently to distinct audio output devices 10, e.g., different indicators are applied to occluding headphones, as compared with stereo paired speakers, as compared with a paired soundbar and non-occluding headset. In some examples, the audio output devices 10 include stereo paired speakers, grouped speakers, speakers paired with an open-ear wearable audio device, a soundbar paired with a wearable audio device, an open-ear wearable audio device paired with a vehicle audio system, etc. In additional implementations, the metadata 130 may include synchronization markers and/or role designations to enable coordinated playback across a set of two or more devices 10. For example, a wearable audio device 10 may be instructed to render only spatial effects while a paired soundbar renders dialog or low-frequency effects, with both synchronized to a shared clock or frame reference.

As noted herein, particular implementations include evaluating metadata 130 for characteristics indicative of audio device output. In some cases, the metadata 130 is evaluated by the processor(s) 40 at audio device 10. In particular examples, such as where the audio device 10 includes a wearable audio device or portable audio device, that audio device 10 can have limited processing capability. In such cases, the control program 90 enables metadata-based analysis of the audio file or stream 120 with relatively limited processing capability. In other cases, the metadata 130 is evaluated by the processor(s) 40 at device 20, e.g., a smart device and/or source device.

Further, as noted herein, metadata 130 about the audio file or stream 120 can be provided in any of a number of mechanisms. For example, the metadata 130 can be provided with a metadata transport mechanism including one or more of: file-embedded tags, Bluetooth transport protocols, Wi-Fi, general wireless protocols, non-audible transports such as ultrasound, encoded carrier signals in the audio content, or a companion data channel associated with the audio file or stream 120. In some examples, the metadata 130 is appended to the title of the content (e.g., content in the audio file or stream 120). In certain examples, the content type is indicated by a set of content-based features represented by a unique two-letter code (e.g., MU, PO, SW, etc.). In some examples, the content type is one of a group of predefined content types.

In particular cases, the processor 40 is configured to analyze metadata 130 across multiple metadata transport paths, including both embedded and out-of-band mechanisms. In further non-limiting examples, the processor 40 is configured to analyze metadata 130 across at least the following metadata transport (or, delivery) paths:
(I) Classic Bluetooth (BR/EDR): (a) AVRCP (e.g., title, artist, album), which can include standard media metadata, with limited customization; (b) A2DP, which supports ID3 tag passthrough in MP3; and metadata embedded in audio stream; and (c) HFP, which includes call-related metadata (e.g., name, number); and is relevant for hands-free mode.
(II) Bluetooth Low Energy (BLE): (a) GATT, which includes custom services and characteristics for spatial and/or audio effect metadata; (b) LE Audio+MCS, which includes low-latency control over playback metadata and commands; and (c) Periodic Advertising/AUX Data, which includes venue broadcast scenarios (e.g., theaters, public spaces).
(III) Embedded Metadata in Audio Files: (a) ID3 tags (MP3/AAC), which supports descriptive and prescriptive fields; (b) Ogg/Vorbis comments, which is beneficially customizable for FLAC/Opus; and (c) ADTS (AAC), including in-band signaling in live broadcasts.
(IV) Hybrid/Advanced Formats: (a) BLE+AVRCP, including mixed transport, for example, BLE for advanced metadata, AVRCP for core fields; (b) BLE+LE Audio ISO Channels, for example using synchronized metadata via isochronous channels; and (c) Codec-native metadata (e.g., Dolby Atmos) embedded spatialization data in the audio bitstream.

While various implementations describe selecting audio output settings (e.g., signal processing settings and/or audio output modes) based on detected characteristics of metadata 130, additional implementations include selecting the audio output settings and/or modifying the audio output settings based on at least one secondary factor detectable at the audio device 10 and/or device 20. In some cases, the secondary factor includes one or more of: user movement (e.g., as indicated by sensors in electronics 80 at audio device 10), proximity to a multimedia device (e.g., as indicated by communications-based proximity detection such as BT signal strength, common Wi-Fi network detection, etc.), proximity to an external speaker (e.g., as indicated by communications-based proximity detection such as BT signal strength, BT Channel Sounding, common Wi-Fi network detection, etc.), proximity to another wearable audio device (e.g., as indicated by communications-based proximity detection such as BT signal strength, previous device pairing, etc.), or presence in a vehicle (e.g., as indicated by communications-based proximity detection such as BT signal strength, previous device pairing, etc.).

In further implementations, a digital audio workstation (DAW) plug-in 200 is provided (FIG. 1), e.g., via a device 20 and/or in connection with service 100, enabling a user to assign metadata to audio files or streams 120. In particular cases, the DAW plug-in 200 includes a menu of metadata assignment options. In some aspects, the menu of metadata assignment options includes options for assigning at least one of prescriptive metadata or descriptive metadata to each audio file or audio stream 120. For example, the menu of metadata assignment options can include options for assigning prescriptive metadata to each audio file or stream 120 such as defining equalization, distribution, virtual speakers, level, spatialization, or anchoring. In certain cases, the DAW plug-in 200 can be provided as an audio development and/or editing tool for a user creating, categorizing, or otherwise packaging audio files or streams 120, e.g., for distribution.

In still further implementations, a method includes: (A) classifying a library of audio files or audio streams 120 according to content type (e.g., Music (MU), Podcast (PO), Movie (MO), Spoken Word (SW), Episodic (EP), or Gaming (GA)); and (B) appending the library with metadata classifiers for subsequent playback according to the metadata 130 in a standard audio format. In some cases, the group of content types is predefined, e.g., according to a limited list of content types such Music (MU), Podcast (PO), Movie (MO), Spoken Word (SW), Episodic (EP), and Gaming (GA).

### Example Modes

As noted herein, particular implementations include metadata-based audio control, e.g., signal processing. In particular implementations, content creators and/or distributors can select or otherwise designate predefined character strings (e.g., in one or more metadata transport paths) to provide context for signal processing of content at an audio device 10 (e.g., wearable audio device such as headphones). Signal processing can be applied based on one or more modes, and can be device 10 (e.g., wearable device type, model, etc.) specific. Modes can be invoked automatically based on metadata 130. In some cases, the selected mode (or other audio output preference) can be overridden, e.g., via a user command. The disclosed approaches can aid in delivering audio content as the creator intended. Further, the disclosed approaches can ensure that users do not receive an unintended degraded audio experience (e.g., double spatialization).

In particular cases, as noted herein, output modes are predefined. In other examples, modes can be created or assigned on content-by-content basis, and/or created as hybrids of existing predefined modes. Example modes can include (among others), immersive, loudspeaker, and EQ. Other modes are also possible.

Immersive Modes: In some cases, immersive modes describe targeted processing modes to be invoked on an audio device 10 for a desirable listening experience. These modes enable content creators to tailor the playback experience according to the type and preparation of the content. Immersive modes can be disabled, or enabled to provide immersive content. When enabled, examples of immersive content can include (among others):

Full Rotation: Beneficial for content that has already been binaurally prepared, such as binaural audio recordings, immersive headphone mixes, or other mixes intended for headphone playback. This mode allows user interactivity by keeping the audio image oriented to the space around the user as she turns her head.

Center Channel Extraction: Separates the center-image content (such as dialogue) and anchors it to the space around the listener while allowing all other content outside the center image to move with the listener's head movements. This hybrid experience can be beneficial for pre-binaurally encoded content, like object-based (e.g., ATMOS) headphone-rendered movies with dialog elements in the center channel.

Loudspeaker Presentation: Virtualizes stereo to speakers placed +/−30 degrees from center, maintaining the listener in desired zone (or “sweet spot(s)”) with IMU inputs (e.g., from the wearable audio device electronics). This can be beneficial for content intended to be rendered on loudspeakers. Loudspeaker Presentation can include (among others):
(I) Small room: Can be beneficial for content mixed for playback in an intimate setting. The room size setting determines the length of reflections in the simulated virtual room.
(II) Large room: This can be beneficial for content mixed for playback in a larger, open setting. The room size setting determines the length of reflections in the simulated virtual room.

EQ Modes: EQ modes can allow content creators to set the desired equalization for a “reference” listening experience, which can include (in non-limiting examples):

Flat Response: EQ settings providing a flat frequency response, ensuring that the audio is as accurate as possible and closely reflects the original studio mix; and

Default/User Controlled: This mode defaults to either the device (e.g., wearable) EQ tuning or the user-selected EQ tuning.

As noted herein, content types may include but are not limited to: Music (MU), Podcast (PO), Movie (MO), Spoken Word (SW), and Episodic (EP). In some cases, the content types describe the nature of the content and determine if the audio device pauses or attenuates audio during interruptions. This may impact SpeakEasy signal processing, impacting how content is treated when the listener is interrupted. In some examples, for MU, the content is typically attenuated but not paused during interruptions. In further examples, for PO, content is likely paused during interruptions. In additional examples, for MO, content is likely paused during interruptions. In further examples, for SW, content is likely paused during interruptions. In still further examples, for EP, content is likely paused during interruptions.

Particular implementations can beneficially provide structured encoding for audio content, which can be selected by content creators, distributors, or intermediaries. In some examples, a tagging structure is used, e.g., with specific encoding. In one particular, non-limiting example, ID3 tagging is used, with two-letter encoding.

Certain examples rely on a structured encoding in a text field using multi-letter representation. In certain of these cases, each feature combination is represented by a unique two-letter code, with a short signature (e.g., device maker signature such as BOS) at the start to identify the metadata as specific to a device maker (e.g., Bose Corporation). The metadata can be parsed from left to right, allowing future features to be added at the end of the string.

### Examples of Multi-Letter Encoding Scheme

BOS Signature: starts the metadata string for a particular device type (e.g., indicating a Bose Corporation device)
Immersive Disabled: DS
Immersive Full Rotation: FR
Immersive Center Channel Extraction: CE
Loudspeaker Small Room: SR
Loudspeaker Large Room: LR
Flat Response EQ: EQ
EQ Default/User Controlled: DC
Music: MU
Podcast: PO
Movie: MO
Spoken Word: SW
Episodic: EP
In particular implementations, features can be combined, e.g., two or more features can be combined in a string. For example: Podcast (PO)+Immersive Full Rotation (FR)+Flat Response EQ (EQ): Combined Code: BOSPOFREQ.

Various tags are possible for different content types, e.g., ID3 Tags. Non-limiting examples of ID3 Tags are shown below, with tags encapsulated in {brackets} and appended at the end of the title field in the ID3 data:
Song example (Immersive Small Room, Default EQ): {BOSSRDCMU}, which can be appended to the Title as:
Title: “Song Title {BOSSRDCMU}”.
Podcast example (Immersive Disabled, Default EQ): {BOSDSPODC}, which can be appended to the Title as:
Title: “Podcast Title {BOSDSPODC}”.
Movie example (Immersive Center Channel Extraction, Flat Response EQ):
{BOSCEEQMO}, which can be appended to the Title as:
Title: “Movie Title {BOSCEEQMO}”.

### Additional Examples

In further implementations, processor 40 can be configured to analyze metadata 130 for instructions on synchronization and/or coordination of playback across multiple devices, e.g., across multiple audio devices 10. In certain cases, metadata 130 can include time alignment indicators and/or role-based rendering indicators (e.g., wearable audio device plus soundbar in shared environments) that can be evaluated to adjust or otherwise assign output modes.

Further implementations enable source-side metadata generation, e.g., authoring and/or appending metadata 130 for audio files or streams 120 using playback sources (e.g., device(s) 20) such as mobile applications on smart devices, audio-visual (AV) receivers, and/or venue sound systems (e.g., soundboards). In some cases, the control program 90 can be run at any processor at a playback source to enable authoring and/or appending metadata 130 to audio files or streams 120. Further, DAW 200 can be run as a program and/or application at any device described herein to enable source-side metadata generation.

Additional implementations can enhance cross-device compliance and schema enforcement, for example, by standardizing interpretation of metadata 130 across third-party devices (e.g., devices 20). For example, metadata 130 can be authored and/or appended to audio files or streams 120 in a consistent manner to enable certification and compliance across a plurality of distinct device types (e.g., devices varying by manufacturer, operating system, platform, etc.).

Further implementations enable distribution of metadata 130 in a scalable platform, e.g., via broadcast or another communications protocol. In some cases, metadata 130 can be broadcast simultaneously to multiple devices using a communications protocol such as BLE, LE Audio, or other transport layers. In particular cases, this can enhance audio output control across a plurality of devices, e.g., with grouped speakers, multiple audio systems, paired audio devices 10, etc.

Various implementations can enhance the user experience, e.g., by applying desirable audio signal processing (or modes) based on content type. Further, these implementations can beneficially enable content creators, distributors, etc., to assign content indicators to content in metadata. These metadata tags enable content creators to preselect the desirable signal processing for their content, enabling a premium listening experience as the content creator intended. In particular cases, users can override these settings by disabling automatic features (or select features of such modes) on their audio devices (e.g., via device interface and/or via connected smart device). Certain of the disclosed structured tagging approaches, can enable low-friction adoption of content identification and enhance the creator and user experiences.

In any case, the approaches described according to various implementations have the technical effect of enhancing audio output for a user based on the detected type of audio content. For example, the approaches described according to various implementations efficiently identify audio content type to tailor audio output at one or more speaker systems. Further, the approaches described according to various implementations can effectively identify types of audio content with specific metadata, making adoption of these approaches by various content providers more efficient. Users of the disclosed systems and methods experience an enhanced audio experience when compared with conventional systems.

Particular implementation described herein are configured to be deployed at an audio device and/or at a connected smart device. One or both devices can include a controller including one or more microcontrollers or processors having a digital signal processor (DSP). In some cases, the controller is referred to as control circuit(s). The controller(s) may be implemented as a chipset of chips that include separate and multiple analog and digital processors. The controller may provide, for example, for coordination of other components of the audio device, such as control of user interfaces (not shown) and applications run by the audio device. In various implementations, controller includes a metadata-based audio control module (or program), which can include software and/or hardware for performing audio control processes described herein. For example, controller can include metadata-based audio control module in the form of a software stack having instructions for controlling functions in outputting audio to one or more audio devices in a system according to any implementation described herein. As described herein, the controller, as well as other controller(s) described herein, is configured to control functions in audio output according to various implementations. In addition to a controller as described herein, an audio device can further include at least one transducer for providing an audio output (e.g., electro-acoustic transducers), at least one microphone (e.g., a microphone array), a communications unit (e.g., including a wireless communication system such as a BT module), along with additional electronics such as orientation sensors, optical sensors, capacitive sensors, user interfaces, etc.

Additional aspects of audio control (e.g., spatialization), for example, in open ear, on ear or in-ear audio devices, are described in U.S. Pat. No. 10,972,857 (“Directional Audio Selection”), U.S. Pat. No. 10,929,099 (“Spatialized Virtual Personal Assistant”) and U.S. Pat. No. 11,036,464 (“Spatialized Augmented Reality (AR) Audio Menu”), each of which is incorporated here by reference in its entirety.

The above description provides embodiments that are compatible with BLUETOOTH SPECIFICATION Version 5.2 [Vol 0], 31 Dec. 2019, as well as any previous version(s), e.g., version 4.x and 5.x devices. Additionally, the connection techniques described herein could be used for Bluetooth LE Audio, such as to help establish a unicast connection. Further, it should be understood that the approach is equally applicable to other wireless protocols (e.g., non-Bluetooth, future versions of Bluetooth, and so forth) in which communication channels are selectively established between pairs of stations.

In some implementations, the host-based elements of the approach are implemented in a software module (e.g., an “App”) that is downloaded and installed on the source/host (e.g., a “smartphone,” television, soundbar, or smart speaker), in order to provide the spatialized audio output aspects according to the approaches described above.

While the above describes a particular order of operations performed by certain implementations of the invention, it should be understood that such order is illustrative, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

The functionality described herein, or portions thereof, and its various modifications (hereinafter “the functions”) can be implemented, at least in part, via a computer program product, e.g., a computer program tangibly embodied in an information carrier, such as one or more non-transitory machine-readable media, for execution by, or to control the operation of, one or more data processing apparatus, e.g., a programmable processor, a computer, multiple computers, and/or programmable logic components.

A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a network.

Actions associated with implementing all or part of the functions can be performed by one or more programmable processors executing one or more computer programs to perform the functions of the calibration process. All or part of the functions can be implemented as, special purpose logic circuitry, e.g., an FPGA and/or an ASIC (application-specific integrated circuit). Processors suitable for the execution of a computer program include, by way of example, both general and special purpose microprocessors, and any one or more processors of any kind of digital computer. Generally, a processor will receive instructions and data from a read-only memory or a random access memory or both. Components of a computer include a processor for executing instructions and one or more memory devices for storing instructions and data.

In various implementations, unless otherwise noted, electronic components described as being “coupled” can be linked via conventional hard-wired and/or wireless means such that these electronic components can communicate data with one another. Additionally, sub-components within a given component can be considered to be linked via conventional pathways, which may not necessarily be illustrated.

A number of implementations have been described. Nevertheless, it will be understood that additional modifications may be made without departing from the scope of the inventive concepts described herein, and, accordingly, other embodiments are within the scope of the following claims.

We claim:

1. A method of controlling audio device output, comprising:
receiving an audio file or audio stream for output at an audio device, the audio file or audio stream provided with metadata defining audio output settings, wherein the audio file or audio stream is in a standard format,
evaluating the metadata for corresponding output capabilities at the audio device, and
if the audio device does not have corresponding output capabilities defined by the metadata, outputting the audio file or audio stream in the standard format.

2. The method of claim 1, wherein the metadata includes at least one of descriptive metadata or prescriptive metadata.

3. The method of claim 2, wherein the metadata includes both descriptive metadata and prescriptive metadata.

4. The method of claim 2, further comprising, if the metadata includes prescriptive metadata, applying specified signal processing instructions to audio output at the audio device according to the prescriptive metadata.

5. The method of claim 4, wherein the prescriptive metadata specifies how to render content in the audio file or audio stream with the specified signal processing instructions that are configured to override conflicting default audio output settings for the audio device.

6. The method of claim 2, further comprising, if the metadata includes descriptive metadata and not prescriptive metadata, selecting an output mode for the audio output at the audio device from a predefined set of output modes.

7. The method of claim 2, wherein the descriptive metadata describes the nature of content in the audio file or the audio stream, wherein selecting output mode is based on heuristics or predefined rules according to the nature of the content.

8. The method of claim 1, wherein if the audio device has corresponding output capabilities defined by the metadata, outputting the audio file or audio stream according to the metadata by applying at least one of: an equalization adjustment, a spatialization adjustment, a virtualization adjustment, or an anchoring adjustment to the audio file or audio stream.

9. The method of claim 1, wherein the standard format includes at least one of a stereo format or a stereo transport format.

10. The method of claim 1, wherein the metadata includes a set of indicators of audio output settings based on audio output device type.

11. The method of claim 10, wherein the set of indicators includes two or more indicators for assigning audio output settings in response to detecting two or more audio output devices, wherein the set of indicators is applied differently to distinct audio output devices.

12. The method of claim 1, further comprising:
receiving an input from a user interface to disable the metadata-based evaluation for corresponding output capabilities at the audio device, and
outputting the audio file or audio stream in the standard format in response to receiving the input.

13. The method of claim 1, wherein the evaluating is performed at the audio device.

14. The method of claim 13, wherein the audio device has limited processing capability.

15. The method of claim 1, wherein the metadata is provided with a metadata transport mechanism.

16. The method of claim 1, wherein the metadata is provided via at least one of: file-embedded tags, Bluetooth transport protocols, or a companion data channel associated with the audio stream.

17. The method of claim 1, wherein evaluating the metadata is performed automatically without user input.

18. The method of claim 1, further comprising providing a digital audio workstation (DAW) plug-in with a menu of metadata assignment options,
wherein the menu of metadata assignment options includes options for assigning at least one of prescriptive metadata or descriptive metadata to each audio file or audio stream.

19. The method of claim 1, further comprising:
classifying a library of audio files or audio streams according to content type; and
appending the library with metadata classifiers for subsequent playback according to the metadata in a standard audio format.

20. The method of claim 1, wherein the audio device includes at least one of: an audio headset, a fixed speaker, a portable speaker, or a vehicle audio system.
